(19) United States
(12) Patent Application Publication
(10) Pub. No.: US 2026/0307049 A1
(43) Pub. Date: Oct. 8, 2026

(54) OXIME-BASED ADSORBENTS AND METHODS OF USE FOR SELECTIVE SEPARATION OF RARE EARTH ELEMENTS

(71) Applicant: THE BOARD OF REGENTS OF THE UNIVERSITY OF OKLAHOMA, Norman, OK (US)

(72) Inventors: Ngoc Thi-Nhu BUI, Norman, OK (US); Thi Cam Van LE, Norman, OK (US)

(73) Assignee: THE BOARD OF REGENTS OF THE UNIVERSITY OF OKLAHOMA, Norman, OK (US)

(21) Appl. No.: 19/687,824

(22) Filed: May 26, 2026

Related U.S. Application Data
(63) Continuation-in-part of application No. PCT/US2024/057477, filed on Nov. 26, 2024.
(60) Provisional application No. 63/604,133, filed on Nov. 29, 2023.

(51) Int. Cl. B01J 20/22; C22B 3/24; C22B 59/00

(52) U.S. Cl. CPC B01J 20/226; C22B 3/24; C22B 59/00

(57) ABSTRACT

A metal-based nanostructure produced from an oxime-based supramolecular framework compound. A method using the metal-based nanostructure to separate one or more rare earth elements (REEs) from a solution comprising the one or more REEs. A rare earth material comprising the one or more REEs complexed with the metal-based nanostructure. The one or more REEs may be selected from, for example, the group Ce, Dy, Er, Eu, Gd, Ho, La, Lu, Nd, Pm, Pr, Sc, Sm, Tb, Tm, Y, and Yb. The method may be used to separate the REE from an ore or mineral such as bastnasite, monazite, laterite clays, xenotime, loparite, allanite, apatite, fluorite, gadolinite, perovskite, sphene, or zircon

### CROSS-REFERENCE TO RELATED APPLICATIONS

The present patent application is a continuation-in-part of International Patent Application No. PCT/US2024/057477, filed Nov. 26, 2024, which claims priority under 35 U.S.C. 119(e) to the U.S provisional patent application identified as U.S. Ser. No. 63/604,133, filed on Nov. 29, 2023, both of which are hereby incorporated by reference herein in their entireties.

### STATEMENT REGARDING FEDERALLY SPONSORED RESEARCH AND DEVELOPMENT

N/A

### BACKGROUND

Ensuring an undisrupted supply of critical metals, especially technologically essential elements characterized as having geopolitically concentrated production and low rates of end-of-life recycling, is critical for technologies such as electronics, medical imaging, energy-efficient lighting, solar energy, and others. Furthermore, recovery of metals from wastewaters and brines through separating and recycling is important energetically, economically, and environmentally.

Rare earth elements (REEs) possess distinctive and varied electronic properties, having great potential application in many fields of advanced technology, particularly with regard to the new generation of sustainable energy applications, e.g. wind turbines, high-capacity energy storage, and new energy vehicles, car batteries, magnets. Due to their intriguing properties, demand for REEs is predicted to soar rapidly in the upcoming years, corresponding to the fast pace of technological innovation. Supply of REEs will therefore struggle to match demand, necessitating society to recycle from spent materials to ensure long-term supplies. Unlike the common practice recycling of metals such as iron, copper, or nickel, the recovery and recyclization of REEs is tremendously challenging and energy-intensive since REEs are present only in trace quantities. Moreover, they have almost similar chemical and physical properties (e.g., valence electron configurations, ionic radii) which further intensifies the challenges of separating them when they occur in the same ores, wastewaters, or brines.

Conventional methods for recovery REEs include leaching techniques, in which ores are dissolved in a chemical pond and then REE ions are concentrated and extracted from other components in the pond. Considering the environmental concerns regarding excessive amounts of leaching agents, Wang et al designed an innovative REE mining technique, electrokinetic mining, achieving ~80% decrease in leaching agent usage. Wang et al separated REEs from metallic impurities (e.g., Al³⁺, Fe³⁺, Ca²⁺, etc.), but the method still required an additional step for individual REE separation. Historically, other methods for separating REEs have included precipitation, solvent extraction, ion exchange, and adsorption, Solubility-based separation methods like precipitation share common disadvantages, such as excessive chemical use and waste production. Solvent extractions are not technically or economically feasible for processing low-grade feedstocks, owing to their limited selectivity and requiring many extraction stages and large amounts of organic solvents.^{[16]} Furthermore, although ion-exchange can be selective and environmentally friendly, the materials used for separation are costly and have limited capacity. Other methods such as adsorption and biology also have advantages and disadvantages in terms of separation efficiency and cost-effectiveness.

Adsorption methods for the separation REEs have disadvantages but can work effectively in ambient conditions and under a wide range of pH. The method can be contextualized into commercialized methods for metal ion recovery. Various porous materials have been applied for the capture of REEs, including graphene oxide, activated carbon, zeolite, metal-organic frameworks (MOFs), covalent organic frameworks (COFs), and others. However, current state-of-the-art materials have limited separation efficiencies for REE separation, especially when separating REEs with similar ionic radii and chemical properties. The most daunting and sought-after goal is an adsorbent platform that can selectively capture specific ions in the REEs group. It is to address this goal that the present disclosure is directed.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the inventive concepts disclosed herein.

The patent or application file contains at least one drawing executed in color. Copies of this patent or patent application publication with color drawing(s) will be provided by the Office upon request and payment of the necessary fee.

FIG. 1 shows a schematic illustration of various aspects of the oxime-based coordination complex adsorbents (oCCAs) of the present disclosure, such as their morphologies and use in fabricating membrane platforms for selective REE separation.

FIG. 2 shows exemplary oxime structures and scanning electron microscope (SEM) images of the oCCAs made using benzamide oxime (A), 4-methylbenzamide oxime (B), 4-aminobenzamide oxime (C), and 2-chlorobenzaldehyde oxime (D).

FIG. 3 shows varous properties of the oCCAs (A-D) of FIG. 1: (a) Powder X-Ray diffraction (PXRD), (b) Fourier-transformed infrared spectroscopy (FT-IR), (c) Zeta potentials, (d) adsorption efficiencies for La³⁺, Ce³⁺ and Nd³⁺, (e) separation factor for Ce³⁺ vs. La³⁺, and Nd³⁺ vs. Ce³⁺, and (f) released Zn²⁺ concentrations due to transmetalation between guest ions and zinc nodes in host oCCAs when being exposed to equimolar aqueous solutions of La³⁺, Ce³⁺ and Nd³⁺ REEs (of 10 ppm each).

FIG. 4 shows solvated ion sizes of REEs and REEs adsorption and separation behaviors of 4-aminobenzamide oxime-based oCCA from multicomponent REE mixtures. Samples were exposed to equimolar aqueous solutions of (a) La³⁺ and Ce³⁺, (b) La³⁺, Ce³⁺, Nd³⁺, (c) La³⁺, Ce³⁺, Nd³⁺, Y³⁺, Eu³⁺ and Tb³⁺ (of 10 ppm each).

FIG. 5 shows morphological control and effects of adsorbent structures on REEs separation behaviors using 4-aminobenzamide oxime-based oCCAs: (a) SEM images of sheet and donut structures; (b) PXRD, (c) FT-IR, (d) Brunauer-Emmett-Teller (BET) surface area analysis and (e) Zeta potential characterizations; (f) adsorption efficiency and (g) separation factor of 4-aminobenzamide oxime-based oCCAs with sheet and donut structures in comparison with commercial resin 1 (AmberChrom™ 50WX4) and resin 2 (AmberChrom™ 50WX8).

FIG. 6 shows (a) FT-IR in a range of 390-4000 cm⁻¹, and (b) UV-Vis of the oxime-based coordination complex adsorbents: (A) benzamide oxime, (B) 4-methylbenzamide oxime, (C) 4-aminobenzamide oxime and (D) 2-chlorobenzaldehyde oxime.

FIG. 7 shows how background NaCl impacts the adsorption efficiencies and REEs separating capabilities of 4-aminobenzamide oxime-based oCCA adsorbent when exposed to equimolar aqueous solutions of (a, b) a mixture of two ions La³⁺ and Ce³⁺ and (c, d) a mixture of three ions La³⁺, Ce³⁺ and Nd³⁺ (~10 ppm) in NaCl solutions with concentration ranging from 0 to 1M.

FIG. 8 shows (a) FT-IR in a range of 390-4000 cm⁻¹, and (b) UV-vis of the 4-aminobenzamide oxime-based coordination complex adsorbents with sheet and donut structures.

FIG. 9 shows levels of Zn²⁺ released during REEs adsorption using 4-aminobenzamide oxime-based oCCAs with sheet and donut structures.

FIG. 10 shows SEM images of (a,b) PVDF, (c,d) oCCA-C/PVDF-PDA-PEI (sheet) membranes synthesized in the absence of a viscosity enhancer.

FIG. 11 shows SEM images of (a) PVDF, (b) oCCA-C/PVDF-PDA-PEI (donut) membranes; (c) enlarged image and (d) energy dispersive X-ray spectroscopy (EDS) mapping of oCCA/PVDF-PDA-PEI (donut) synthesized in the presence of polyvinyl alcohol (PVA) 1 wt. (%).

FIG. 12 shows SEM images of oCCA-C/PVDF-PDA-PEI (donut) membranes synthesized in the presence of polyethylene glycol (PEG) 1 wt. (%).

FIG. 13 shows SEM images and element analysis obtained in EDS of oCCA-C/PVDF-PDA-PEI (backbone) membranes synthesized in the sonication bath at 0, 30, 60 and 120 min.

FIG. 14 shows REEs adsorptive separation behaviors of oCCA-C/PVDF-PDA-PEI membranes: adsorption efficiency, separation factor, and released Zn²⁺ amount of oCCA-C/PVDF-PDA-PEI when exposed to equimolar aqueous solutions of La³⁺, Ce³⁺ and Nd³⁺ REEs (of ~1 ppm each) membranes (a,d,g) sheet, (b,e,h) donut, and (c,f,i) cube.

FIG. 15 shows REEs adsorptive separation behaviors with different initial REEs concentration: adsorption efficiency, separation factor, and released Zn²⁺ amount of oCCA-C/PVDF-PDA-PEI (sheet) when exposed to equimolar aqueous solutions of La³⁺, Ce³⁺ and Nd³⁺ REEs with initial concentration of each (a,c,e) ~1 ppm and (b,d,f) ~5 ppm.

### DETAILED DESCRIPTION

The present disclosure describes, in at least one embodiment, methods for the preparation and use of oxime-based crystal adsorbents, which may be referred to as oxime-based coordination complex adsorbents (oCCAs), for efficient and selective separation of rare earth elements (REEs) from aqueous environments. The REE group includes at least the 17 elements Ce, Dy, Er, Eu, Gd, Ho, La, Lu, Nd, Pm, Pr, Sc, Sm, Tb, Tm, Y, and Yb. First, the particular oxime ligand used to make each oCCA has been found to play a role in the particular morphologies and structures of oCCAs. For example, rhombic dodecahedra, cubes, hexagonal sheets, and spheres were formed when benzamide oxime, 4-methylbenzamide oxime, 4-aminobenzamide oxime, and 2-chlorobenzaldehyde oxime were used, respectively, as metal chelators in the reactions. Second, the selective REE capture behaviors of the oCCAs can be fine-tuned by adjusting the functional groups in the oxime ligands used to form the oCCAs. Electron-donating or electron-withdrawing groups have observable impacts on the ion capture behaviors of oCCAs, which may be due to their effects on the electron density and coordination stability of the resulting complexes. Of the OCCAs tested herein, the form constructed using 4-aminobenzamide oxime displayed the most effective REE adsorption capacity and separation factor. In addition, effects of background sodium chloride, often encountered in several wastewater streams, on REE separating performance of oCCAs were investigated. The approach used in the present disclosure offers a valuable method to accelerate the discovery of new materials that can be synthesized efficiently and with ease toward augmenting REEs for various industrial applications. In at least certain embodiments of the present disclosure, the REE aqueous environment which is treated according to the method disclosed herein is obtained by dissolving an ore or mineral containing a plurality of different REEs. Examples of such ores and minerals include but are not limited to bastnasite, monazite, laterite clays, xenotime, loparite, allanite, apatite, fluorite, gadolinite, perovskite, sphene (titanite), and zircon.

As noted above, REEs are crucial for modern technologies, spanning from electronic devices to high-powered magnets, rechargeable batteries, solar energy, medical imaging, and other products essential for the transition toward a zero-carbon future. The recycling of metals such as iron, copper, aluminum, nickel, and tin is a common practice. However, the recyclization of REEs, especially at trace levels, from end-of-use products and waste streams has been found to be environmentally-challenging and energy-intensive. Therefore, as the demand for REEs continues to increase, there is a pressing need for more efficient and cost-effective methods for their separation and recovery. Herein, we demonstrate the design and evaluation of oxime-based coordination complex adsorbents (oCCAs) for efficient selective rare earth ion separation from water environments. We also demonstrate the capability to fine-tune the potential of oCCAs to separate REEs by controlling the electron-donating or electron-withdrawing properties of the functional groups in the oxime ligands used to form the oCCAs. As mentioned above, oCCA synthesized using 4-aminobenzamide oxime exhibited the highest REE adsorption efficiency and separation factor.

Before further describing various embodiments of the present disclosure in more detail by way of exemplary description, examples, and results, it is to be understood that the compounds, compositions, and methods of present disclosure are not limited in application to the details of specific embodiments and examples as set forth in the following description. The description provided herein is intended for purposes of illustration only and is not intended to be construed in a limiting sense. As such, the language used herein is intended to be given the broadest possible scope and meaning, and the embodiments and examples are meant to be exemplary, not exhaustive. Also, it is to be understood that the phraseology and terminology employed herein is for the purpose of description only and should not be regarded as limiting unless otherwise indicated as so. In the description below, numerous specific details are set forth in order to provide a more thorough understanding of the present disclosure. However, it will be apparent to a person having ordinary skill in the art that the present disclosure may be practiced without these specific details. In other instances, features which are well known to persons of ordinary skill in the art have not been described in detail to avoid unnecessary complication of the description. It is intended that all alternatives, substitutions, modifications, and equivalents apparent to those having ordinary skill in the art are included within the scope of the present disclosure. Thus, while the compounds, compositions, and methods of the present disclosure have been described in terms of particular embodiments, it will be apparent to those of skill in the art that variations may be applied to the compounds, compositions, and methods and in the steps or in the sequence of steps of the methods described herein without departing from the concept, spirit, and scope of the inventive concepts.

Each patent, published patent application, and non-patent publication referenced in any portion of this application, including U.S. Provisional Patent Application No. 63/517,297 and International Patent Application No. PCT/US2024/057477, is expressly incorporated herein by reference in its entirety to the same extent as if the individual patent, or published patent application, or non-patent publication was specifically and individually indicated to be incorporated by reference.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

The following abbreviations may be used herein:
Å: Angstrom,
BET: Brunauer-Emmett-Teller,
COF: covalent organic frameworks,
EDL: electrical double layer,
EDS: Energy dispersive X-ray spectroscopy,
FT-IR: Fourier-transform infrared spectroscopy,
ICP-OES: Inductively coupled plasma-optical emission spectroscopy,
MOF: metal-organic framework,
MW: molecular weight,
oCCA: oxime-based coordination complex adsorbent,
PDA: polydopamine,
PEG: poly(ethylene glycol),
PEI: polyethyleneimine,
PVA: poly(vinyl alcohol),
PVDF: polyvinylidene fluoride,
PXRD: Powder X-Ray diffraction,
REE: Rare earth element,
SEM: scanning electron microscope,
Ce: Cerium,
Dy: Dysprosium,
Er: Erbium,
Eu: Europium,
Gd: Gadolinium,
Ho: Holmium,
La: Lanthanum,
Lu: Lutetium,
NaCl: Sodium Chloride,
Nd: Neodymium,
Pm: Promethium,
Pr: Praseodymium,
Sc: Scandium,
Sm: Samarium,
Tb: Terbium,
Tm: Thulium,
Y: Yttrium,
Yb: Ytterbium,
Zn: Zinc.

As utilized in accordance with the methods and compositions of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The term “plurality” refers to two or more items. Where used herein, the specific term “single” is limited to only “one,” and a “pair” means two.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, of 1-10, 10-20, 20-30, 30-40, 40-50, 50-60, 60-75, 75-100, 100-150, 150-200, 200-250, 250-300, 300-400, 400-500, 500-750, 750-1,000, includes ranges of 1-20, 10-50, 50-100, 100-500, and 500-1,000, for example.

As noted above, any numerical range listed or described herein is intended to include, implicitly or explicitly, any number or sub-range within the range, particularly all integers, including the end points, and is to be considered as having been so stated. For example, “a range from 1.0 to 10.0” is to be read as indicating each possible number, including integers and fractions, along the continuum between and including 1.0 and 10.0, that is, having a minimum value equal to or greater than 1.0 and a maximum value equal to or less than 10.0, such as, for example, 3.25 to 8.65. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Thus, even if a particular data point within the range is not explicitly identified or specifically referred to, it is to be understood that any data points within the range are to be considered to have been specified, and that the inventor(s) possessed knowledge of the entire range and the points within the range.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the composition, the method used to administer the composition, or the variation that exists among the study subjects. As used herein the qualifiers “about” or “approximately” are intended to include not only the exact value, amount, degree, orientation, or other qualified characteristic or value, but are intended to include some slight variations due to measuring error, manufacturing tolerances, observer error, and combinations thereof, for example. The term “about” or “approximately”, where used herein when referring to a measurable value such as an amount, a temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 80% of the time, at least 90% of the time, at least 91% of the time, at least 92% of the time, at least 93% of the time, at least 94% of the time, at least 95% of the time, at least 96% of the time, at least 97% of the time, at least 98% of the time, or at least 99% of the time.

As used herein any reference to “one embodiment” or “an embodiment” means that a particular element, feature, composition, structure, or characteristic described in connection with the embodiment is included in at least one embodiment. The appearances of the phrase “in one embodiment” in various places in the specification are not necessarily all referring to the same embodiment.

The term “wt %” (a.k.a., “wt/wt %” and “% (w/w)”) when used in reference to a solute is a measure of the concentration of a solute in a solution in terms of the mass of the solute and the mass of the solvent in which the solute is dissolved. The soluteₘₐₛₛ+the solventmass=the solutionmasₛ. Wt % is calculated by dividing the soluteₘₐₛₛ by the solutionmass, then multiplying the resulting quotient by 100.

The term “substrate” may also be used interchangeably herein with the term “membrane support.”

Where reference is made herein to a step of “passing the aqueous solution across the metal-based nanostructure,” it is intended to refer to a step in which an aqueous solution is passed over a stationary substrate comprising the metal based nanostructures, or is passed across a membrane interface having the oCCA acting as an active layer, or is passed through a packed-bed column or container holding the metal-based nanostructures, or wherein a quantity of the metal based nanostructure is mixed with an aqueous solution then separated therefrom. Thus the step is not to be limited to passing an aqueous solution over or through a stationary mass of the metal-based nanostructures.

Examples of oxime ligands that can be used to make the compounds of the present disclosure include, but are not limited to, salicylaldoxime, benzaldehyde oxime, acetophenone oxime, cyclohexanone oxime, α-benzoin oxime, 4-pyridinecarbaldehyde oxime, 2-pyridinecarbaldehyde oxime, 5-methoxynicotinaldehyde oxime, 5,6-dimethoxypicolinaldehyde oxime, 3,4,5-trimethoxybenzaldehyde oxime, benzamide oxime, 4-methylbenzamide oxime, 4-aminobenzamide oxime, and 2-chlorobenzaldehyde oxime.

Examples of zinc salts that can be used to make the compounds of the present disclosure include but are not limited to zinc nitrate (Zn(NO₃)₂), zinc acetate (Zn(OAc)₂), zinc chloride (ZnCl₂), zinc sulfate (ZnSO₄), and zinc acetylacetonate (Zn(C₅H₇O₂)₂).

Imidazole ligands that may be used in the methods of the present disclosure include, but are not limited to, benzimidazole, benzylimidazole, 1-methyl-1H-imidazole-4-sulfonyl chloride, 5-amino-3H-imidazole-4-carboxamide, 1-[(1-methyl-1H-imidazol-2-yl)sulfonyl]-1H-benzotriazole, 1-ethyl-2-methyl-1H-imidazole-4-sulfonyl chloride, 1-methylimidazole-2-sulfonyl chloride, 2-chlorobenzimidazole, 1-boc-imidazole, 1-(3-aminopropyl) imidazole, and 4-(trifluoromethyl)-1H-imidazole.

Where used herein, the pronouns “we” or “us” or the possessive determiner “our” are intended to refer to all persons involved in a particular aspect of the investigation disclosed herein and as such may include non-inventor laboratory personnel, assistants, technicians, collaborators and/or contributors who worked under the supervision of the inventor(s), and thus are not intended to represent an inventorship role by said laboratory personnel, assistants, technicians, collaborators, and/or contributors in any subject matter disclosed herein.

The term “exemplary” where used herein is intended to refer to non-limiting examples, instances, or illustrations, and is not intended to mean that the referenced examples have any particular merit or value above other examples.

Techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

The order of execution or performance of the operations or steps in examples of the disclosure illustrated and described herein is not essential, unless otherwise specified. That is, the operations may be performed in any order, unless otherwise specified, and examples of the disclosure may include additional or fewer operations or steps than those disclosed herein. For example, it is contemplated that executing or performing a particular operation or step before, contemporaneously with, or after another operation or step is within the scope of aspects of the disclosure. It will be understood that the benefits and advantages described above may relate to one embodiment or may relate to several embodiments.

Certain novel embodiments of the present disclosure, having now been generally described, will be more readily understood by reference to the following examples, which are included merely for purposes of illustration of certain aspects and embodiments of the present disclosure, and are not intended to be limiting. The following examples are to be construed, as noted above, only as illustrative, and not as limiting of the present disclosure in any way whatsoever. Those skilled in the art will promptly recognize appropriate variations from the various compositions, structures, components, procedures and methods.

### Methods

### Chemicals and Reagents

Zinc(II) nitrate hexahydrate (≥98%), 2-methylimidazole (>99%), benzamide oxime (≥99%), 4-methylbenzamide oxime (>99%), 4-aminobenzamide oxime (>99%) 2-chlorobenzaldehyde oxime (>99%), sodium chloride, lanthanium chloride heptahydrate, neodymium (III) chloride hexahydrate, cerium (III) chloride heptahydrate, europium (III) chloride hexahydrate, terbium (III) chloride hexahydrate and yttrium (III) chloride hexahydrate, dopamine hydrochloride (MW of 189.64 g/mol), polyethyleneimine (PEI, MW of 800 g/mol), trizma base, poly(vinyl alcohol) (PVA, MW of 146,000-186,000 g/mol), and poly(ethylene glycol) (PEG, MW of 146,000-186,000 g/mol) were purchased from Sigma-Aldrich and used as received. Polyvinylidenefluoride (PVDF) filter membranes with a diameter of 47 mm, a thickness of 125 μm, and an average pore size of 0.22 μm was provided by Sterlitech (USA). Milli-Q water was used in the synthesis of oCCAs samples and ion solution preparations, respectively.

Fabrication of oCCAs
Synthesis of oCCAs

Zinc imidazole-encoded benzamide oxime-based adsorbent (A) was synthesized by adding Zn(NO₃)₂·6H₂O (0.75 mmol) to a mixture of aqueous solution containing benzamide oxime (4.54 mmol) and 2-methylimidazole (5.95 mmol) at 55° C. and for 2 hours. After synthesis, the adsorbent was separated from the reaction suspension by centrifuging for 15 minutes at 8000 rpm. The product was rinsed with deionized water, followed by centrifugation and re-dispersion in distilled water. This rinsing procedure was performed twice. The final product was decanted from the water and dried overnight in a vacuum oven at room temperature.

Similar methods were used to synthesize other zinc imidazole-encoded oxime-based adsorbents using a subset of oxime ligands varied with different functional groups. Specifically, structure (B) was synthesized using 4-methylbenzamide oxime, structure (C) was synthesized using 4-aminobenzamide oxime, and structure (D) was synthesized using 2-chlorobenzaldehyde oxime.

Morphological Transformation of oCCA-C

Firstly, 0.3400 g of 4-aminobenzamide oxime is added to one-round bottom flask containing 10 mL of H₂O, and the mixture is heated at 55° C. for 25 minutes. Following this, 0.2445 g of 2-methylimidazole is dissolved into 10 mL of H₂O before adding to above solution and heated for additional 35 minutes. Finally, 0.111 g of Zn(NO₃)₂·6H₂O in 1.5 mL of H₂O is added, and the mixture is stirred at 55° C. for 2 hours. This series of steps result in the formation of oCCA-C/PVDF-PDA-PEI with oCCA-C sheet morphology. Additionally, a similar approach was employed to synthesize oCCA-C with a donut morphology, except that 1 wt % PVA or lwt % PEG was used as a solvent instead of DI water.

Fabrication of oCCA-C/PVDF-PDA-PEI Membranes

Prior to oCCA-A deposition, PVDF membrane supports were modified with polydopamine (PDA) and polyethyleneimine (PEI) (PVDF-PDA-PEI) as described in previous reported.

Synthesis of oCCA-C/PVDF-PDA-PEI (Sheet Morphology)

The synthesis process initiates by adding 0.3400 g of 4-Amino benzamide oxime to 10 mL of water and heating the mixture at 55° C. for 25 minutes. Following this step, 0.2445 g of 2-methylimidazole is incorporated into 10 mL of water, and the mixture is heated for an additional 35 minutes until complete dissolution is achieved. Subsequently, the PVDF-PDA-PEI membrane is added into the mixture and stirred for 5 minutes. Subsequently, 0.111 g of Zn(NO₃)₂·6H₂O in 1.5 mL of water is added, and the stirring continues at 55° C. for a duration of 2 hours.

Synthesis of oCCA-C/PVDF-PDA-PEI (Donut Morphology)

An analogous method compared to oCCA-C/PVDF-PDA-PEI (sheet) was utilized to produce oCCA-C with a donut-like structure (oCCA-A/PVDF-PDA-PEI (donut)), with the exception that the solvent employed was either 1 wt % PVA or 1 wt % PEG, in place of DI water.

Synthesis of oCCA-C/PVDF-PDA-PEI (Backbone)

In a 50 mL bottle, 0.3400 g of 4-amino benzamide oxime is dispersed in a 10 mL PVA 1% solution. Subsequently, 0.2445 g of 2-methylimidazole is dissolved in a separate 10 mL PVA 1% solution and then added to the same bottle. The mixture is stirred for 35 minutes until complete dissolution is achieved. The bath sonication temperature is set to reach 55° C., and the prepared mixture is placed in the sonication bath. Following this, the PVDF-PDA-PEI is introduced to the mixture and sonicated for 5 minutes. Additionally, a solution containing 0.111 g of Zn(NO₃)₂·6H₂O in 1.5 mL of PVA 1% solution is added to the mixture. The sonication process continues at a temperature range of 55-60° C. for a total of 2 hours, with a 2-minute gap between each sonication step.

### REEs Adsorption Tests

### REEs Adsorption Tests in Powder Form

### Multiple REEs Separation Experiments

Each adsorption experiment was conducted in a glass vial containing 2.5 mg of adsorbent. A 5 mL of equimolar ionic solution having two REE ions (La³⁺, Ce³⁺), three REE ions (La³⁺, Ce³⁺, Nd³⁺), and six REE ions (La³⁺, Nd³⁺, Ce³⁺, Eu³⁺, Tb³⁺, and Y³⁺), each at ~10 ppm, was added to the vial. Lanthanium chloride heptahydrate, neodymium (III) chloride hexahydrate, cerium (III) chloride heptahydrate, europium (III) chloride hexahydrate, terbium (III) chloride hexahydrate and yttrium (III) chloride hexahydrate were used to prepare the solutions. The pH value of the stock lanthanide chloride solution is ~6. The mixture was then mixed using a roller shaker at 55 rpm at room temperature for 4 hours. Subsequently, the mixture was centrifuged at 8000 rpm for 15 minutes to separate the solid adsorbents from the liquid supernatants, which was then filtered through a 0.22 m membrane filter to obtain a clear sample. After adsorption, the concentration of ions in the mixture was measured using ICP-OES.

### Effects of Background NaCl on REEs Separation Behaviors

To investigate the impacts of ionic strength on the adsorption efficiency and REEs separating capabilities of oCCAs, a glass vial containing 2.5 mg of the adsorbent was filled with a 5 mL mixture of equimolar ionic solution having two REE ions (La³⁺, Ce³⁺) and three REE ions (La³⁺, Ce³⁺, Nd³⁺) (~10 ppm each) in 0 M, 0.01M, 0.1 M and 1 M NaCl background solutions. The vials were mixed at 55 rpm using a roller shaker for 4 hours at room temperature. The mixtures were then centrifuged at 8000 rpm for 5 minutes to separate the solid adsorbents from the supernatants, which were then filtered through 0.22 m membrane filters to obtain clear samples. The concentration of ions in the supernatants were determined with ICP-OES.

The REEs capture efficiencies of oCCA powders are calculated using equation (i) as follows:

$$Efficiency ( \% ) = \frac{{C}_{0} - C}{{C}_{0}} \times 100 \% \qquad ( i )$$

The distribution coefficient and separation factor between other ions including Nd³⁺, and Ce³⁺ and La³⁺ were calculated using equation (ii) and (iii), respectively:

$${K}_{d} = \frac{{C}_{0} - ( {C}_{f} + {C}_{r} )}{{C}_{f} + {C}_{r}} \times \frac{V}{m} \qquad ( ii )$$

$${α}_{M / La} = \frac{{K}_{dM}}{{K}_{dLa}} \qquad ( iii )$$

where C₀ is the initial ion concentration (ppb). C is the equilibrium ion concentration (ppb) after 4 hours, respectively. V (mL) is the volume of mixture ions solution; m (g) is the mass of the oCCA-C; K_{d} is the distribution coefficient (mL/g). α_{M/La} is the separation factor between M³⁺ and ion La³⁺ (M³⁺: Nd³⁺, and Ce³⁺).

### REEs Adsorption Tests in Membrane Form

An H-shaped glass diffusion cell composed of a feeding compartment and a receiving compartment was used in the permeation test. The solutions in both feeding compartment and receiving compartment were agitated by magnetic stirring during the permeation test. The feed compartment filled with 10 mL of equimolar ionic solution having three lanthanide ions (La³⁺, Ce³⁺, Nd³⁺), whereas the receiving compartment filled with 10 mL DI water. The initial of each ion in the tests are: 1023.5±20.2 ppb La³⁺, 1041.9±20.1 ppb Nd³⁺, and 1049.6±20.7 ppb Ce³⁺. Another set of experiment was also carried out with initial of each ion in the tests are: 5199.4 ppb La³⁺, 5383.0 ppb Nd³⁺, and 5533.3 ppb Ce³⁺ as confirmed with ICP-OES. Both feed and receiving solutions were agitated by magnetic stirring during the test. At defined time intervals 30, 60, 120, 180, and 240 min), 0.5 mL of solutions in the feed and receiving compartments were taken for further analyses. These samples were then diluted 10-fold with HNO₃ 2% and analyzed using the ICP-OES analytical method to quantify concentrations of metal ions in each compartment. The experiments are repeated three times.

The REEs capture efficiencies of oCCA-A/PVDF-PDA-PEI membranes are calculated using equation (iv) as follows:

$$Efficiency ( \% ) = \frac{{C}_{0} - ( {C}_{f} + {C}_{r} )}{{C}_{0}} \times 100 \% \qquad ( iv )$$

The distribution coefficient and separation factor between other ions including Nd³⁺, and Ce³⁺ and La³⁺ were calculated using equation (v) and (vi), respectively:

$${K}_{d} = \frac{{C}_{0} - ( {C}_{f} + {C}_{r} )}{{C}_{f} + {C}_{r}} \times \frac{V}{m} \qquad ( v )$$

$${α}_{M / La} = \frac{{K}_{dM}}{{K}_{dLa}} \qquad ( vi )$$

where C₀ is the initial ion concentration (ppb). C_{f} and Cᵣ are the equilibrium ion concentration (ppb) at feed and receiving cells, respectively. V (mL) is the volume of mixture ions solution; m (g) is the mass of the oCCA-C; K_{d} is the distribution coefficient (mL/g). α_{M/La} is the separation factor between M³⁺ and ion La³⁺, (M³⁺: Nd³⁺, and Ce³⁺)
Characterization of oCCAs and oCCA-C/PVDF-PDA-PEI Membranes

The surface morphology of oCCAs and oCCA-C/PVDF-PDA-PEI membranes were characterized with SEM. Chemical composition and element distribution of membrane surfaces were analyzed by EDS using a Zeiss Neon 40EsB FE-SEM/FIB dual beam. PXRD patterns were obtained by a focused-beam Cu K_{α} radiation (K_{α}=1.541 Å) with a continuous scanning procedure, utilizing a step width of 0.01° and a count time of 2 s/step within the range of 5-45. Zeta potential was obtained by Malvern ZetaSizer Nano ZS at Wilhelm Lab Biomedical Nano-Engineering Laboratory. ICP-OES measurements are performed using a Thermo Scientific iCap Pro at Aqueous Geochemistry Laboratory.

### Results

Fabrication of oCCAs with Various Morphology

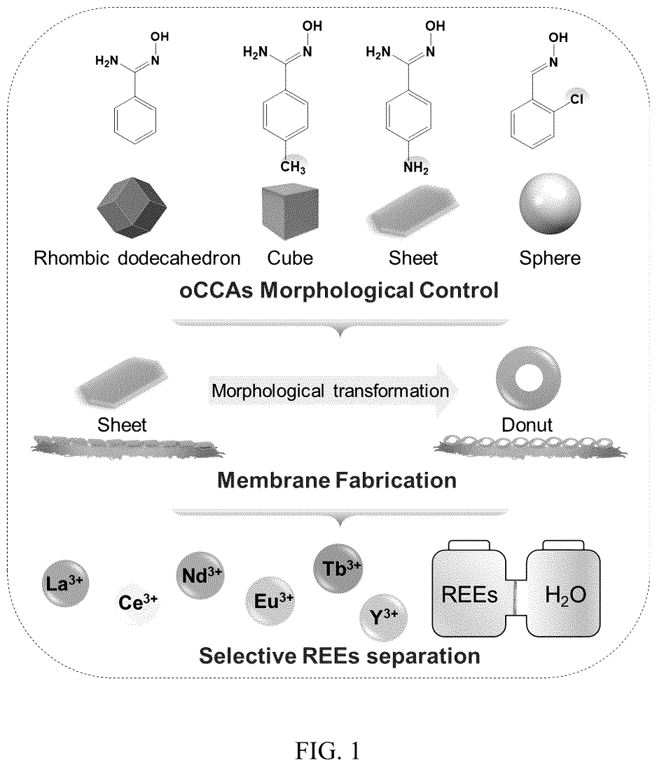

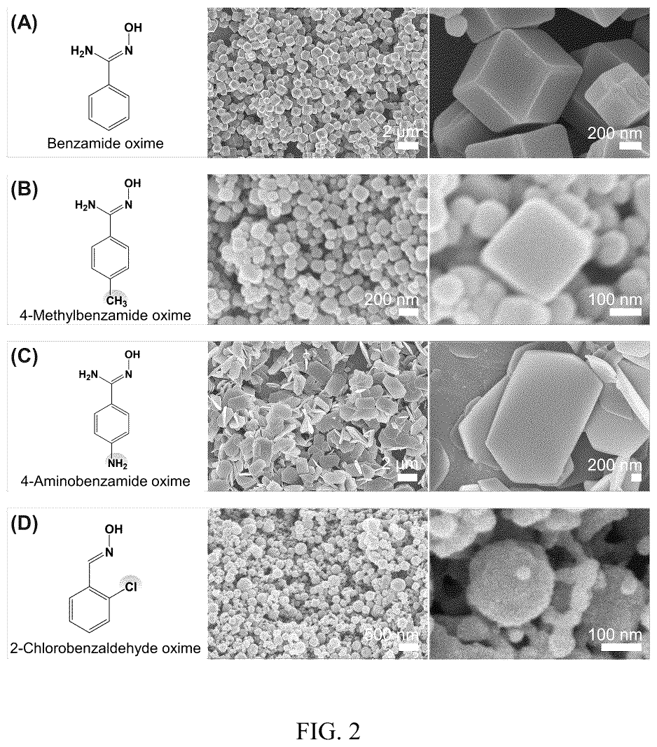

Zinc-based oCCA structures were synthesized using a subset of oxime ligands having different functional groups, including benzamide oxime (A), 4-methylbenzamide oxime (B), 4-aminobenzamide oxime (C) and 2-chlorobenzaldehyde oxime (D). The zinc-based oCCAs were synthesized by a continuous-stirred hydrothermal method at 55° C. for 2 h. The different oxime ligands created oCCAs with distinct morphologies (FIGS. 1-2). Specifically, rhombic dodecahedra was achieved when benzamide oxime was used (oCCA-A), whereas a cubic-like shape was observed for 4-methylbenzamide oxime-derived oCCAs (oCCA-B). Meanwhile, 2D nanosheet and spherical morphologies were obtained for 4-aminobenzamide oxime (oCCA-C) and 2-chlorobenzamide oxime (oCCA-D), respectively. These results demonstrate that oxime structures play a significant role on the resulting morphologies of the zinc-based oCCAs. Production using mild conditions and a non-toxic solvent (e.g., DI water) makes oCCAs an eco-friendly class of materials. In the present design approach, the use of a facile synthesis procedure, water-based solvent, and mild synthetic conditions provides a cost-effective and environmentally sustainable solution to produce REE-adsorbent materials.

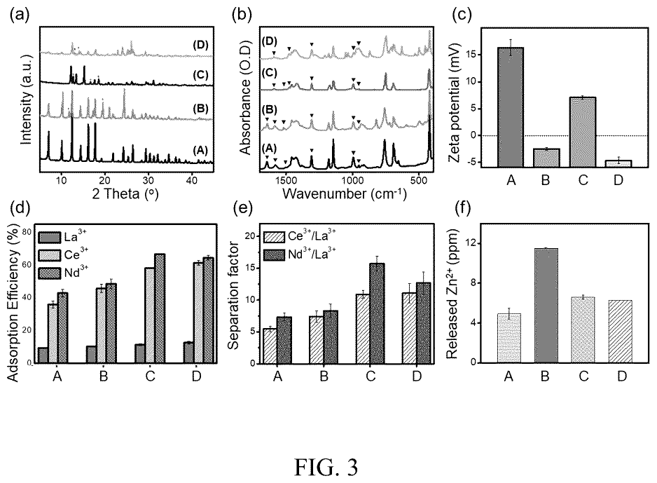

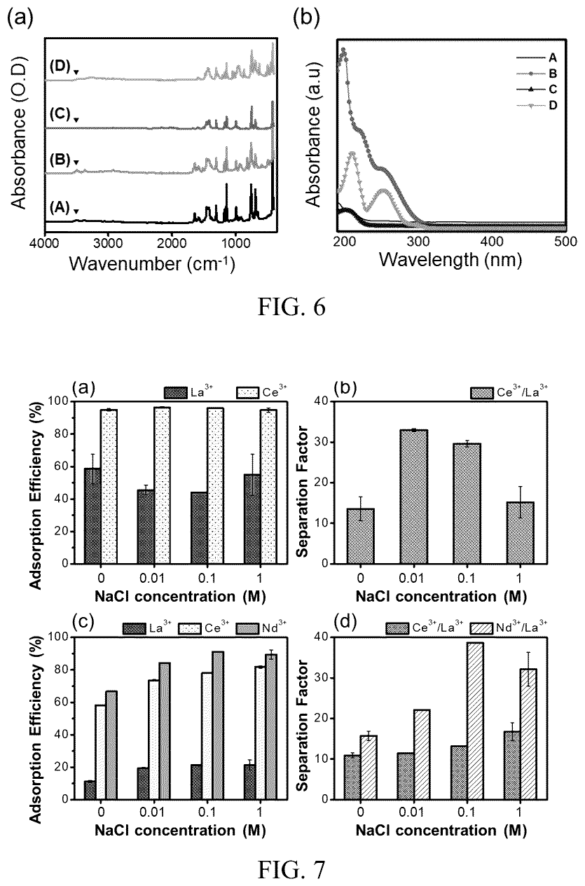

The structure of the oCCAs were evaluated by PXRD and show similarity at 7.1, 10.1, 12.4, 14.4, 16.2, 17.7, 21.8, 28.3, 29.4 and 34.7° C. (FIG. 3(a)). oCCAs show distinct characteristics with the appearance of new patterns as compared to (A) marked in red color. The difference might be attributed to different functional group and coordination in crystal structure. The chemical structure of zinc-based oCCAs were studied further via FT-IR (FIG. 3(b), FIG. 6(a)). The characteristic of carbon vibrations for (A) at 1580, (B) at 1586, (C) at 1591, and (D) at 1592 cm-1 are attributed to aromatic ring carbon-carbon stretching modes. The actual positions of these modes are determined by the form of substitution around the ring. The frequency of vibrations pair is sensitive to substitution for (C) at 1477, and especially (D) at 1478 cm⁻¹ attributed to the frequency of —NH₂, and —Cl functional groups. Amidoxime group vibrations are observed for (A, B, D) at 1308, and (C) at 1307 cm⁻¹ due to 0-H bending mode. Additional modes at 1644 in (A), and 1642 in (B) are attributed to C═N stretching. The deformation mode of the amino group are also observed for (A) at 1502, (B) at 1520, and (C) 1513 cm⁻¹. N—O stretching absorption are observed at 953 cm⁻¹ for four oCCAs. Especially, four oCCAs shares the same mode position at 420 and 692 cm⁻¹ attributing to Zn—N and, Zn—O stretching. UV-vis analysis was carried out as shown in FIG. 6(b). Ligands absorb in the range of (A) 190; (B) 198, 221, 253; (C) 203; 210, (D) 253 nm, respectively, depending on the positions of oxime and functional groups. Considering the charge of an oCCA might influence its adsorption and separation behavior for various REEs, we examined zeta potentials. In samples (A), (B), (C), and (D), zeta potentials were found to be approximately 16.3, −2.5, 7.1, and −4.6 eV, respectively (FIG. 3(c)).

### Adsorption Performance and Selectivity Tests

Effects of Oxime Selection on La³⁺/Ce³⁺/Nd³⁺ Separation

To test the REE selectivity of the as-prepared oCCA materials, experiments with mixtures of pairs of ion or of multiple ions were conducted in which all ion components were equimolar. FIG. 3(d-e) illustrates that adsorbent (C) exhibited the highest adsorption efficiency and separation factor for three REE ions: Ce³⁺, Nd³⁺, and La³⁺, when compared to adsorbents (A), (B), and (D). These three ions are classified as hard Lewis metal ions, suggesting that they could form strong bonds with hard acid groups. We hypothesized that incorporating electron-donating groups (—CH₃, —NH₂) into benzamide oxime may impact the electron density surrounding the oxime nitrogen and hydroxyimino oxygen atoms. The alteration in electron density may lead to the formation of stronger coordination bonds between the active sites of oCCAs and REEs, thereby enhancing the ability of oCCAs to capture La, Ce and Nd ions from water. Also in our hypothesis, the change of electron density surrounding the active adsorption sites of the oCCAs may improve their selectivity toward Ce³⁺ and Nd³⁺ over La³⁺ ions from the mixture. Specifically, adsorbent (C) exhibits significant adsorption selectivity toward Ce³⁺ and Nd³⁺, which is 10 and 15 times more efficient than that toward La³⁺, respectively. It is noteworthy that La³⁺, Nd³⁺, and Ce³⁺ have similar solvated ionic sizes of approximately 1.2 A, making of the capability of adsorbent (C) in differentiating these three ions virtually unique. Interestingly, in the case of adsorbent (D), the addition of —Cl group, an electron-withdrawing group, at the ortho-position with respect to the hydroxyimino group also shows high REEs adsorption efficiency (over 60% for Nd and Ce ions uptake) and separating capability (over 10 times for Nd³⁺ and Ce³⁺ ions compared to La³⁺ ion). FIG. 3(f) shows the released Zn²⁺ concentration indicating transmetalation partly participate in adsorption mechanisms. These electron-donating or electron-withdrawing groups thus can be used to adjust the electron density surrounding the active coordinative sites and can thereby play important roles in controlling REE uptake and selectivity of oCCAs.

Separation Performance of 4-Aminobenzamide Oxime-Based oCCA for a Multiple REEs Mixture

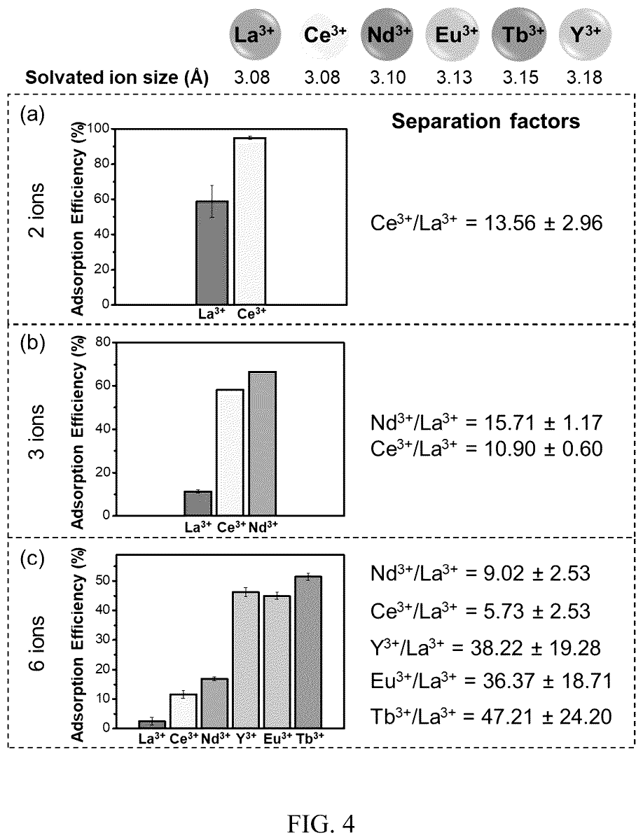

The 4-aminobenzamide oxime-based adsorbent, referred to herein as as oCCA-C, was selected to investigate the separation of mixtures of two, three, and six REE ions: (La³⁺, Ce³⁺), (La³⁺, Ce³⁺, Nd³⁺), and (La³⁺, Nd³⁺, Ce³⁺, Eu³⁺, Tb³⁺, and Y³⁺). FIG. 4 shows that the REE adsorption efficiency of oCCA-C in aqueous solution generally increases with decreasing solvated ionic radii of the REEs in solution. For instance, Tb(III), with a solvated ion size of 3.15 A, is smaller than the solvated ion sizes of La(III) (3.08 Å), Ce(III) (3.08 Å), Nd(III) (3.10 A) and Eu(III) (3.13 A) (FIG. 4, Table 1). However, this trend does not hold with Y (3.18 A). With the increase of atomic number, the Lewis acidity of lanthanide elements gradually increases, the atomic radius gradually decreases. Rare earth ions with higher atomic numbers have more robust Lewis acidity. We hypothesized that smaller ions can approach adsorption sites more closely and form stronger bonds with the adsorption sites of oCCA-C. In addition, REEs with large solvated ion radii may have lower affinities to access adsorption sites of oCCAs due possibly to the steric hindrance surrounding the adsorption sites of oCCAs. Nonetheless, this trend is not observed for Y despite its small ionic radius.

TABLE 1
Characteristics of various REE cations: ionic radius, r,
width of hydration shell, number of water molecules in this
shell (n), Gibbs free energy of hydration (Δ_{hyd} G).

| | Ionic | Width of | | Solvated | |
|---|---|---|---|---|---|
| | radii | hydration | | ion radii | Δ_{hyd}G |
| Cations | (Å) | shell (Å) | n | (Å) | (kJ · mol⁻¹) |
| La³⁺ | 1.05 | 2.03 | 10.3 | 3.08 | −3145 |
| Ce³⁺ | 1.01 | 2.07 | 10.7 | 3.08 | −3200 |
| Nd³⁺ | 0.98 | 2.12 | 11.0 | 3.10 | −3280 |
| Y³⁺ | 0.90 | 2.28 | 12.0 | 3.18 | −3450 |
| Eu³⁺ | 0.95 | 2.18 | 11.4 | 3.13 | −3360 |
| Th³⁺ | 0.92 | 2.23 | 11.7 | 3.15 | −3400 |
| Na⁺ | 1.02 | 1.16 | 3.5 | 2.18 | −365 |
| H⁺ | 0.3 | 3.0 | 12.0 | 3.3 | −1050 |

Effects of Background NaCl on REE Separation Behaviors of 4-Aminobenzamide Oxime-Based oCCA

Considering the practical application of the 4-aminobenzamide oxime-based oCCA adsorbent on REEs capture and recovery from wastewater, the impact of competing ions as well as ionic strength on adsorbents are important. In this regard, the REEs separation behaviors in solutions containing different NaCl concentration, partially representing conditions encountered in several wastewater streams (FIG. 7), were considered. We discovered that the adsorption and separation capabilities of 4-aminobenzamide oxime-derived oCCA are proportional to the concentration of NaCl. Without wishing to be bound by theory, we speculate that the enhanced performance can be attributed to two main factors. First, REEs are positively charged and are subject to repulsive electrostatic forces that are directly related to the surface electrical potential of both REEs and oCCA-C(7.1 eV zeta potential). However, the addition of NaCl increases the ionic strength of the solution, which compresses the electrical double layer (EDL) surrounding the REEs. This compression leads to a decrease in the EDL electrical potential of REEs and subsequently a reduction in the repulsive electrostatic forces acting between REEs and oCCA. Second, the decrease in distance between the REEs and oCCA due to the lower repulsive forces results in an increase in the attractive van der Waals force. As a result, the adsorption and separation efficiency of oCCA increases in the presence of NaCl. Although the coexistence of NaCl is generally considered a drawback challenge to overcome for enhanced separation selectivity in other separation technologies, especially those involve electrochemical processes, the presence of NaCl effectively improved the adsorption and separation behavior of oCCA towards Nd and Ce ions over La ion herein. 4-aminobenzamide oxime-based oCCA performs well not only in simulated water environment but also shows considerable improvement in water environments containing background NaCl.

Effects of Morphology on REEs Separation Behaviors of 4-Aminobenzamide Oxime-Based oCCAs

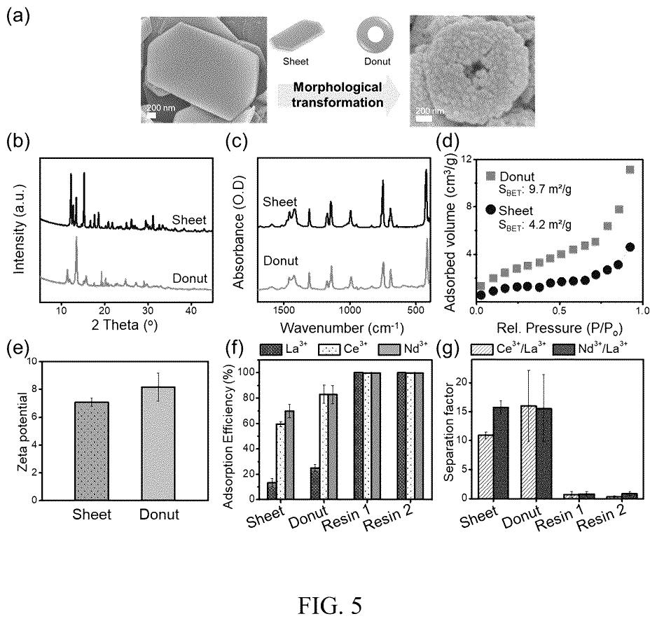

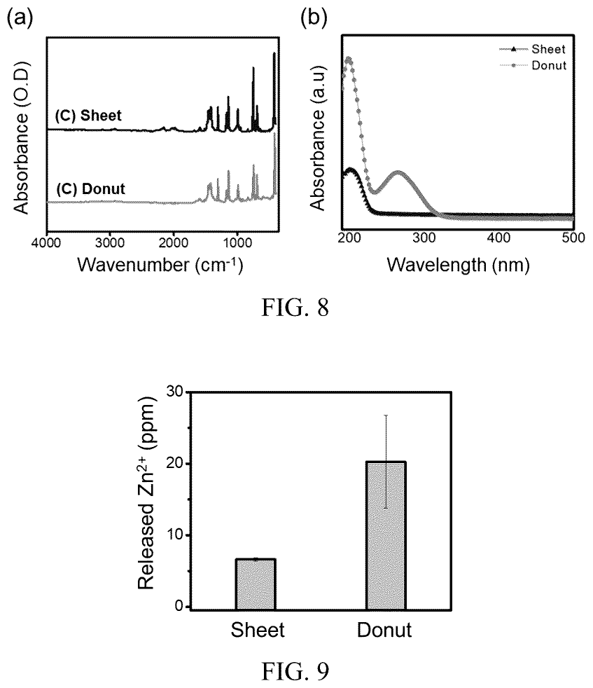

The morphological transformations within oCCA-C and its effect on REEs adsorption behaviors were examined. Controlled synthetic processes were developed by adjusting the reaction medium properties, for example by using poly(vinyl alcohol) (PVA) to tune the oCCA-C sheet into donut shapes (FIG. 5(a)). The sheet and donut structures show slight changes in the PXRD patterns, implying variations in crystalline phases or molecular arrangements. However, the chemical properties and functional groups remain consistent after morphological transformation, as confirmed by the FT-IR analysis (FIG. 5(c), FIG. 8(a)). The oCCA-C with a donut morphology exhibits greater surface area (9.7 m²/g) compared to the sheet morphology (4.2 m²/g), as depicted in FIG. 5(d). The zeta potential of oCCA-C with a donut morphology is slightly higher than that of the sheet morphology (FIG. 5(e)). The tunable morphological of oCCA-C imparts several advantages to its adsorption performance. Specifically, oCCA-C with a donut morphology demonstrates superior REEs adsorption efficiencies compared to the sheet morphology (FIG. 5(f)), while the separation factor remains comparable (FIG. 5(g)). It is worth noting that both oCCA-C structures, with donut or sheet morphology, outperform commercial resins (AmberChrom™ 50WX4 and AmberChrom™ 50WX8) in REEs separation, achieving superior Ce/La and Nd/La separation factors (above 10 and 15, respectively). Furthermore, the concentration of released Zn²⁺ from oCCA-C correlates with its adsorption performance, with the donut morphology exhibiting over twice the amount of Zn²⁺ release compared to the sheet morphology (FIG. 9). We hypothesize that the rough surface of the donut morphology provides more active sites for interactions with REEs, thus enhancing the adsorption efficiency.

4-Aminobenzamide Oxime-Based oCCA Membrane Platforms and its REEs Adsorption/Separation Behavior

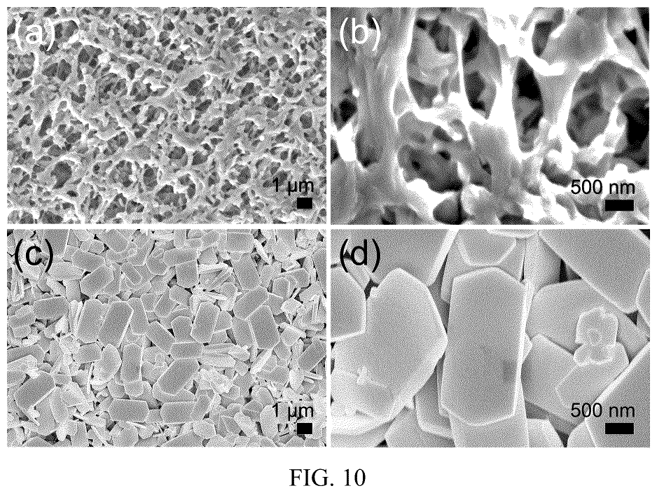

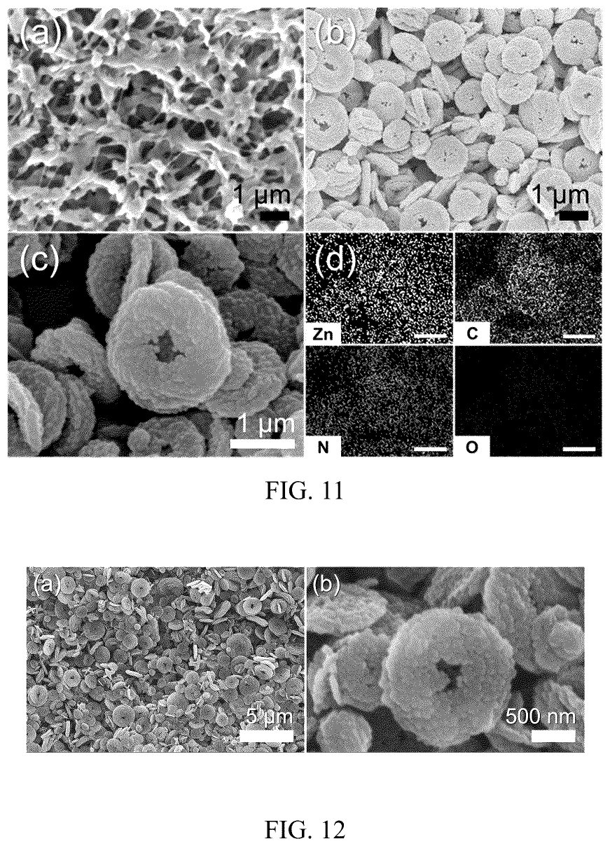

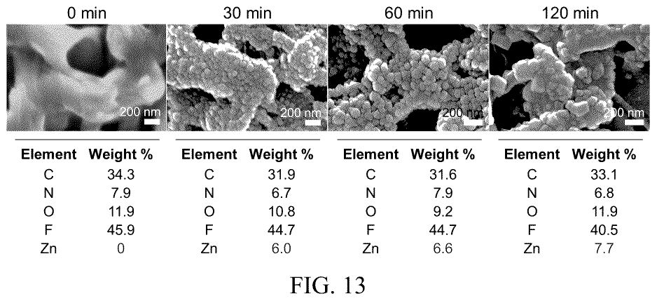

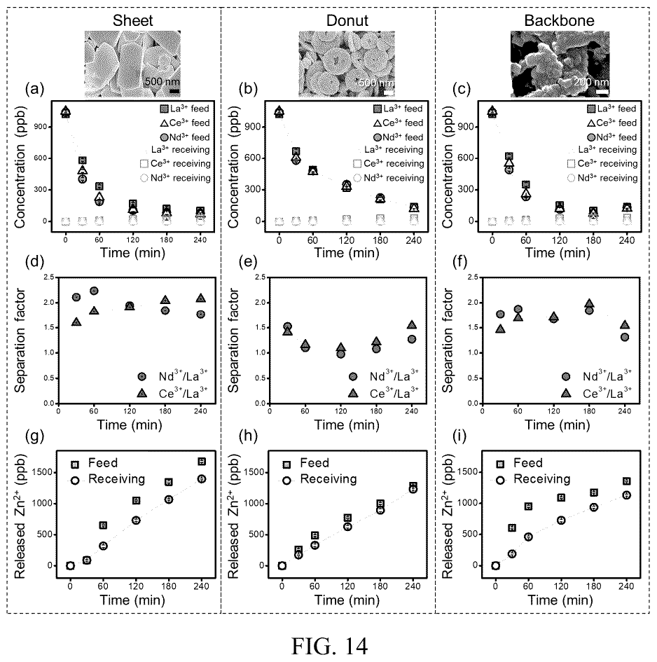

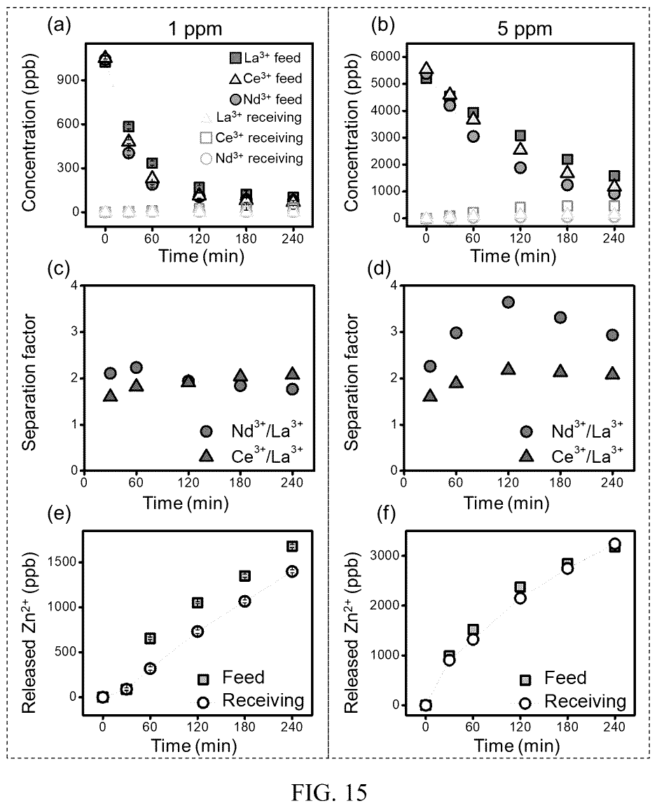

Integration into stable macroscopic structures such as polymeric membranes, 2D materials, porous crystalline materials, and biomimetic channels, is necessary for the oCCAs to be used in practical applications use to perform ion separations. In a non-limiting embodiment of the present disclosure, oCCA-C with sheet or donut morphology were integrated into PVDF-PDA-PEI membrane platforms (FIGS. 10-12). Considering the adhesion improvement, we also successfully synthesized oCCA-C-loaded PVDF-PDA-PEI membrane substrate using sonication-assisted in-situ growth. As time increased, the size of the oCCA adsorbent increased. Furthermore, with increasing time, the observed zinc content also increased, indicating a higher loading amount of oCCA onto the PVDF-PDA-PEI membrane support (FIG. 13). In membrane form, the oCCA-A/PVDF-PDA-PEI (donut) membrane showed lower REEs adsorption efficiency and separation factor compared to membranes comprising the oCCAs with sheet morphology (FIG. 14), whereas the trend is reversed in powdered (non-supported) form. The results imply that packing density plays a considerable role, indicative of the suitability of using the sheet morphology for the generation of adsorptive membrane platforms. However, with an increase of initial REEs concentration from ~1 ppm to ~5 ppm, the Nd³⁺/La³⁺, separation factor enhanced from about 2 to nearly 4 (FIG. 15).

Thus, in accordance with the present disclosure, there have been provided compounds and compositions, as well as methods of producing and using same, which fully satisfy the objectives and advantages set forth hereinabove. Although the present disclosure has been described in conjunction with specific formulas, compounds, compositions, and methods set forth hereinabove, it is evident that many alternatives, modifications, and variations will be apparent to those skilled in the art. Accordingly, it is intended to embrace all such alternatives, modifications, and variations that fall within the spirit and broad scope of the present disclosure.

Accordingly, the present disclosure is directed to at least the following non-limiting embodiments:

Clause 1. A metal-based nanostructure produced by a method comprising the steps of (1) providing a first aqueous solution comprising an imidazole ligand, a second aqueous solution comprising an oxime ligand, and a third aqueous solution comprising a metal salt, (2) combining and mixing the first aqueous solution and the second aqueous solution to form a first mixture, (3) combining and mixing the first mixture with the third aqueous solution in a sealed container to form a reaction mixture, (4) heating the reaction mixture in the sealed container to a predetermined elevated temperature and maintaining the reaction mixture at the elevated for a predetermined period, wherein the reaction mixture forms an oxime-based supramolecular framework compound which preciptates into the metal-based nanostructure, and (5) purifying the metal-based nanostructure.

Clause 2. The metal-based nanostructure of clause 1, wherein the oxime ligand is selected from the group consisting of salicylaldoxime, benzaldehyde oxime, acetophenone oxime, cyclohexanone oxime, α-Benzoin oxime, 4-pyridinecarbaldehyde oxime, 2-pyridinecarbaldehyde oxime, 5-methoxynicotinaldehyde oxime, 5,6-dimethoxypicolinaldehyde oxime, 3,4,5-trimethoxybenzaldehyde oxime, benzamide oxime, 4-methylbenzamide oxime, 4-aminobenzamide oxime, and 2-chlorobenzaldehyde oxime.

Clause 3. The metal-based nanostructure of clause 1 or 2, wherein the imidazole ligand is selected from the group consisting of benzimidazole, benzylimidazole, 1-methyl-1H-imidazole-4-sulfonyl chloride, 5-amino-3H-imidazole-4-carboxamide, 1-[(1-methyl-1H-imidazol-2-yl)sulfonyl]-1H-benzotriazole, 1-ethyl-2-methyl-1H-imidazole-4-sulfonyl chloride, 1-methylimidazole-2-sulfonyl chloride, 2-chlorobenzimidazole, 1-boc-imidazole, 1-(3-aminopropyl) imidazole, and 4-(trifluoromethyl)-1H-imidazole.

Clause 4. The metal-based nanostructure of any one of clauses 1-3, wherein the metal salt is a zinc salt.

Clause 5. The metal-based nanostructure of clause 4, wherein the zinc salt is selected from the group consisting of zinc nitrate (Zn(NO₃)₂), zinc acetate (Zn(OAc)₂), zinc chloride (ZnCl₂), zinc sulfate (ZnSO₄), and zinc acetylacetonate (Zn(C₅H₇O₂)₂).

Clause 6. The metal-based nanostructure of any one of clauses 1-5, wherein the predetermined elevated temperature is in a range of about 30° C. to about 60° C.

Clause 7. The metal-based nanostructure of any one of clauses 1-6, wherein the predetermined period is in a range of about 1 to about 24 hours.

Clause 8. The metal-based nanostructure of any one of clauses 1-7, wherein the predetermined elevated temperature is in a range of about 50° C. to about 60° C.

Clause 9. The metal-based nanostructure of any one of clauses 1-8, wherein the predetermined elevated temperature is about 55° C. and the predetermined period is about 2 hours.

Clause 10. A method of separating a rare earth element (REE) ion from an REE ion-containing aqueous solution, comprising: (1) providing the metal-based nanostructure of any one of claims 1-9; and (2) passing the aqueous solution across the metal-based nanostructure, wherein the REE ion is adsorbed onto the metal-based nanostructure, thereby reducing the concentration of the REE ion in the aqueous solution.

Clause 11. The method of clause 10, the REE ion is selected from the group consisting of Ce, Dy, Er, Eu, Gd, Ho, La, Lu, Nd, Pm, Pr, Sc, Sm, Tb, Tm, Y, and Yb.

Clause 12. The method of clause 10 or 11, the REE ion is preferentially adsorbed onto the metal-based nanostructure as compared to at least one second type of REE ion in the aqueous solution, such that the concentration of the at least one second type of REE ion is increased in the aqueous solution in relation to the concentration of the first-mentioned REE ion.

Clause 13. The method of any one of clauses 10-12, the at least one second type of REE ion is selected from the group consisting of Ce, Dy, Er, Eu, Gd, Ho, La, Lu, Nd, Pm, Pr, Sc, Sm, Tb, Tm, Y, and Yb, with the proviso that the at least one second type of REE ion is different from the first-mentioned REE ion.

Clause 14. The method of any one of clauses 10-13, the metal-based nanostructure is adhered to or disposed on a solid support structure.

Clause 15. The method of any one of clauses 10-14, the metal-based nanostructure is contained within a column or container.

Clause 16. A rare earth material comprising at least one rare earth element (REE) ion complexed with the metal-based nanostructure of any one of claims 1-9, wherein the at least one REE ion is selected from the group consisting of Ce, Dy, Er, Eu, Gd, Ho, La, Lu, Nd, Pm, Pr, Sc, Sm, Tb, Tm, Y, and Yb.

While the present disclosure has been described herein in connection with certain embodiments so that aspects thereof may be more fully understood and appreciated, it is not intended that the present disclosure be limited to these particular embodiments. On the contrary, it is intended that all alternatives, modifications and equivalents are included within the scope of the present disclosure as defined herein. Thus the examples described above, which include particular embodiments, will serve to illustrate the practice of the inventive concepts of the present disclosure, it being understood that the particulars shown are by way of example and for purposes of illustrative discussion of particular embodiments only and are presented in the cause of providing what is believed to be the most useful and readily understood description of procedures as well as of the principles and conceptual aspects of the present disclosure. Changes may be made in the formulation of the various compositions described herein, the methods described herein or in the steps or the sequence of steps of the methods described herein without departing from the spirit and scope of the present disclosure. Further, while various embodiments of the present disclosure have been described in claims herein below, it is not intended that the present disclosure be limited to these particular claims.

What is claimed is:

1. A metal-based adsorbent produced by a method comprising the steps of:
providing a first aqueous solution comprising an imidazole ligand, a second aqueous solution comprising an oxime ligand, and a third aqueous solution comprising a metal salt;
combining and mixing the first aqueous solution and the second aqueous solution to form a first mixture;
combining and mixing the first mixture with the third aqueous solution in a sealed container to form a reaction mixture;
heating the reaction mixture in the sealed container to a predetermined elevated temperature and maintaining the reaction mixture at the predetermined elevated temperature for a predetermined period, wherein the reaction mixture forms an oxime-based supramolecular framework compound which precipitates into the metal-based adsorbent; and
purifying the metal-based adsorbent.

2. The metal-based adsorbent of claim 1, wherein the oxime ligand is selected from the group consisting of 4-aminobenzamide oxime, salicylaldoxime, benzaldehyde oxime, acetophenone oxime, cyclohexanone oxime, α-Benzoin oxime, 4-pyridinecarbaldehyde oxime, 2-pyridinecarbaldehyde oxime, 5-methoxynicotinaldehyde oxime, 5,6-dimethoxypicolinaldehyde oxime, 3,4,5-trimethoxybenzaldehyde oxime, benzamide oxime, 4-methylbenzamide oxime, and 2-chlorobenzaldehyde oxime.

3. The metal-based adsorbent of claim 1, wherein the imidazole ligand is selected from the group consisting of benzimidazole, benzylimidazole, 1-methyl-1H-imidazole-4-sulfonyl chloride, 5-amino-3H-imidazole-4-carboxamide, 1-[(1-methyl-1H-imidazol-2-yl)sulfonyl]-1H-benzotriazole, 1-ethyl-2-methyl-1H-imidazole-4-sulfonyl chloride, 1-methylimidazole-2-sulfonyl chloride, 2-chlorobenzimidazole, 1-boc-imidazole, 1-(3-aminopropyl) imidazole, and 4-(trifluoromethyl)-1H-imidazole.

4. The metal-based adsorbent of claim 1, wherein the metal salt is a zinc salt.

5. The metal-based adsorbent of claim 1, wherein the metal salt is selected from the group consisting of zinc nitrate (Zn(NO₃)₂), zinc acetate (Zn(OAc)₂), zinc chloride (ZnCl₂), zinc sulfate (ZnSO₄), and zinc acetylacetonate (Zn(C₅H₇O₂)₂).

6. The metal-based adsorbent of claim 1, wherein the predetermined elevated temperature is in a range of about 30° C. to about 65° C.

7. The metal-based adsorbent of claim 1, wherein the predetermined elevated temperature is in a range of about 50° C. to about 60° C.

8. The metal-based adsorbent of claim 1, wherein the predetermined period is in a range of about 1 to about 24 hours.

9. The metal-based adsorbent of claim 1, wherein the predetermined elevated temperature is about 55° C. and the predetermined period is about 2 hours.

10. The metal-based adsorbent of claim 1, wherein the oxime ligand used to produce the metal-based adsorbent is 4-aminobenzamide oxime.

11. A rare earth material comprising at least one rare earth element (REE) ion complexed with the metal-based nanostructure of claim 1, wherein the at least one REE ion is selected from the group consisting of Nd, Ce, Dy, Er, Eu, Gd, Ho, La, Lu, Pm, Pr, Sc, Sm, Tb, Tm, Y, and Yb.

12. The rare earth material of claim 11, wherein the at least one REE ion is Nd.

13. The rare earth material of claim 11, wherein the oxime ligand used to produce the metal-based adsorbent is 4-aminobenzamide oxime.

14. The rare earth material of claim 11, wherein the REE is obtained from bastnasite.

15. A method of purifying a rare earth element (REE) ion, comprising:
providing an REE ion-containing aqueous solution;
providing the metal-based adsorbent of claim 1; and
passing the REE ion-containing aqueous solution across the metal-based adsorbent, wherein the REE ion is adsorbed onto the metal-based adsorbent to form a rare earth material, thereby reducing the concentration of the REE ion in the REE ion-containing aqueous solution.

16. The method of claim 15, wherein the REE ion is selected from the group consisting of Nd, Ce, Dy, Er, Eu, Gd, Ho, La, Lu, Pm, Pr, Sc, Sm, Tb, Tm, Y, and Yb.

17. The method of claim 15, wherein the REE ion is Nd.

18. The method of claim 15, wherein the REE ion is preferentially adsorbed onto the metal-based adsorbent as compared to at least one second type of REE ion in the aqueous solution, such that the concentration of the at least one second type of REE ion is increased in the aqueous solution in relation to the concentration of the first-mentioned REE ion.

19. The method of claim 18, wherein the at least one second type of REE ion is selected from the group consisting of Nd, Ce, Dy, Er, Eu, Gd, Ho, La, Lu, Pm, Pr, Sc, Sm, Tb, Tm, Y, and Yb, with the proviso that the at least one second type of REE ion is different from the first-mentioned REE ion.

20. The method of claim 15, wherein the metal-based adsorbent is adhered to or disposed on a solid support structure.

21. The method of claim 15, wherein the metal-based adsorbent is contained within a column or container.

22. The method of claim 15, further comprising a step of separating the REE ion from the rare earth material to form a concentrated solution of the REE.

23. The method of claim 15, wherein the oxime ligand used to produce the metal-based adsorbent is 4-aminobenzamide oxime.

24. The method of claim 15, wherein the REE ion-containing aqueous solution is produced from bastnasite.

25. The method of claim 15, wherein the REE ion-containing aqueous solution is produced from an ore or mineral selected from monazite, laterite clays, xenotime, loparite, allanite, apatite, fluorite, gadolinite, perovskite, sphene, and zircon.
